(19) United States
(12) Patent Application Publication
(10) Pub. No.: US 2026/0303470 A1
(43) Pub. Date: Oct. 1, 2026

(54) SECURITY POLICY ENFORCEMENT PER USER EQUIPMENT (UE) BEHAVIOR IN MOBILE NETWORKS

(71) Applicant: Palo Alto Networks, Inc., Santa Clara, CA (US)

(72) Inventors: Sachin Verma, Pleasanton, CA (US); Leonid Burakovsky, Pleasanton, CA (US)

(21) Appl. No.: 19/096,411

(22) Filed: Mar. 31, 2025

Related U.S. Application Data
(60) Provisional application No. 63/780,059, filed on Mar. 28, 2025.

(51) Int. Cl. H04L 41/147; H04L 9/40; H04W 28/18; H04W 48/02

(52) U.S. Cl. CPC H04L 41/147; H04L 63/205; H04W 28/18; H04W 48/02

(57) ABSTRACT

Techniques for providing security policy enforcement per User Equipment (UE) behavior are disclosed. In some embodiments, a system, a process, and/or a computer program product for providing security policy enforcement per UE behavior in mobile networks includes sending a request to subscribe to analytics information from an Application Function (AF) to a mobile core network; receiving an analytics information response from the mobile core network at the AF; and applying security policy enforcement based on User Equipment (UE) behavior using the AF based at least in part on one or more UE behaviors configured in a security policy based on the analytics information response.

### CROSS REFERENCE TO OTHER APPLICATIONS

This application claims priority to U.S. Provisional Patent Application No. 63/780,059 entitled SECURITY POLICY ENFORCEMENT PER USER EQUIPMENT (UE) BEHAVIOR IN MOBILE NETWORKS filed Mar. 28, 2025, which is incorporated herein by reference for all purposes.

### BACKGROUND OF THE INVENTION

A firewall generally protects networks from unauthorized access while permitting authorized communications to pass through the firewall. A firewall is typically a device or a set of devices, or software executed on a device, such as a computer, which provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRA WINGS

Various embodiments of the invention are disclosed in the following detailed description and the accompanying drawings.

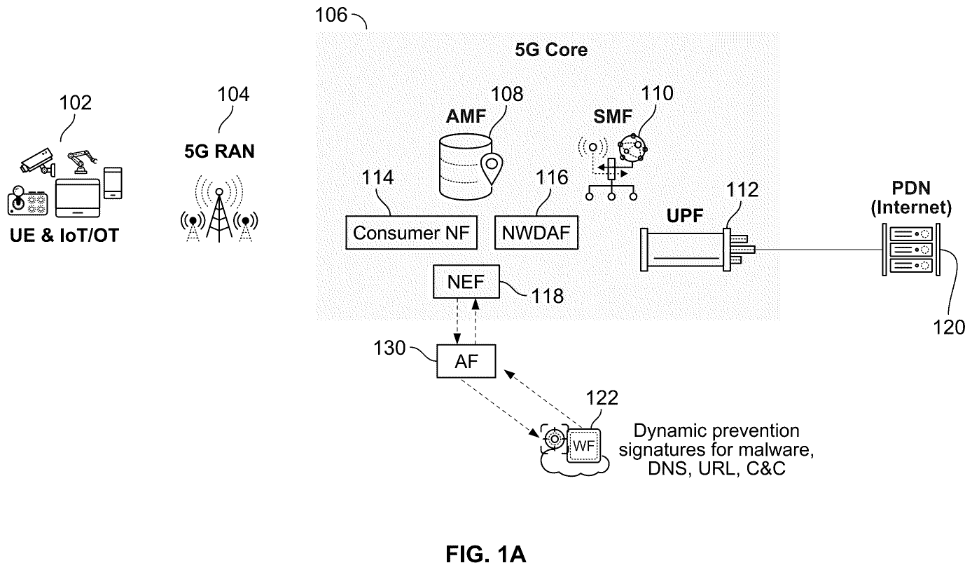

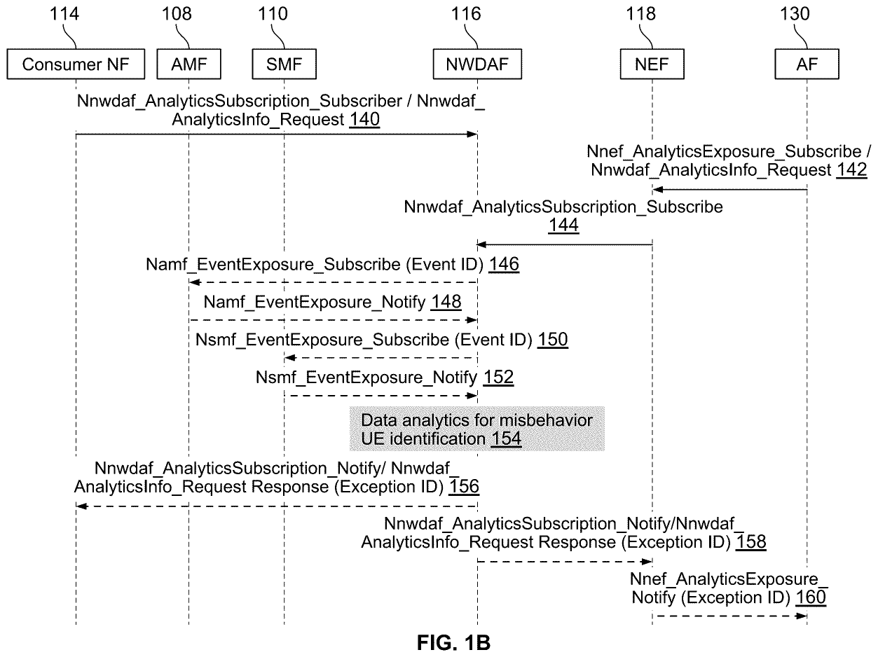

FIG. 1A is an example deployment architecture diagram for providing security policy enforcement per User Equipment (UE) behavior in mobile networks in accordance with some embodiments.

FIG. 1B is a sequence diagram for providing security policy enforcement per UE behavior in mobile networks in accordance with some embodiments.

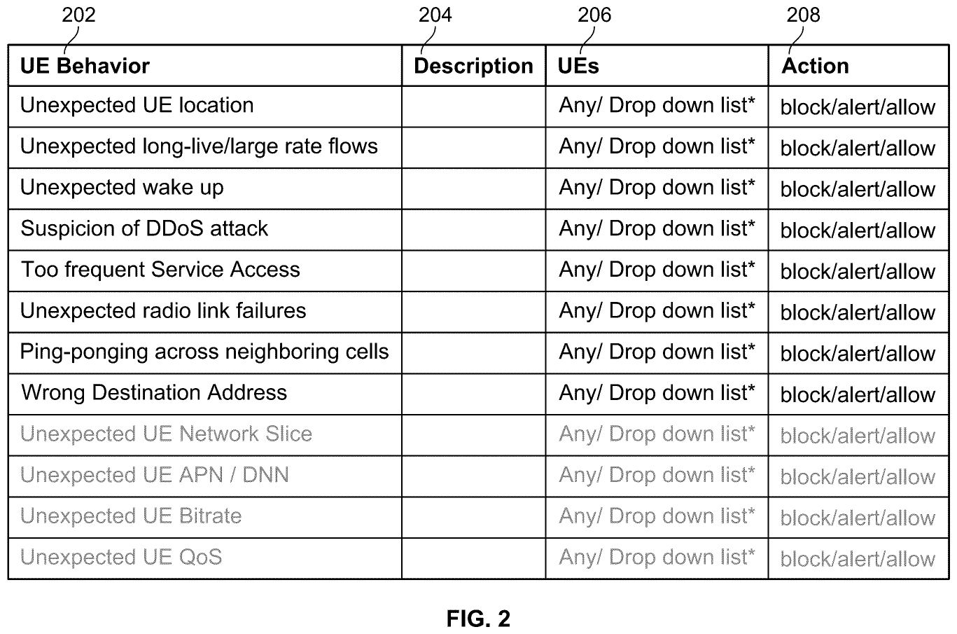

FIG. 2 is a table illustrating an example security policy per UE behavior in mobile networks in accordance with some embodiments.

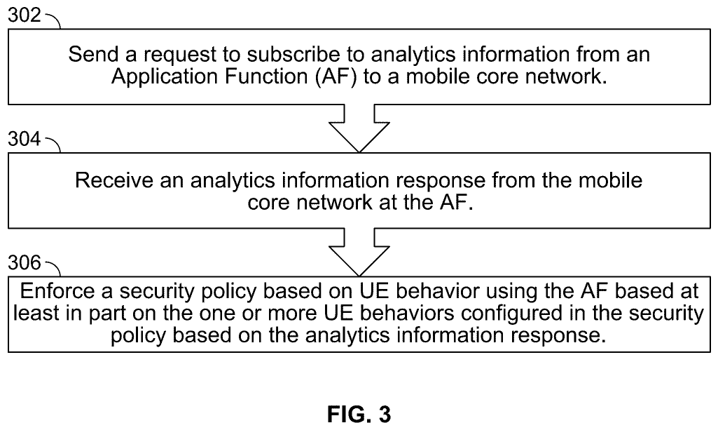

FIG. 3 is a flow diagram of a process for providing security policy enforcement per UE behavior in mobile networks in accordance with some embodiments.

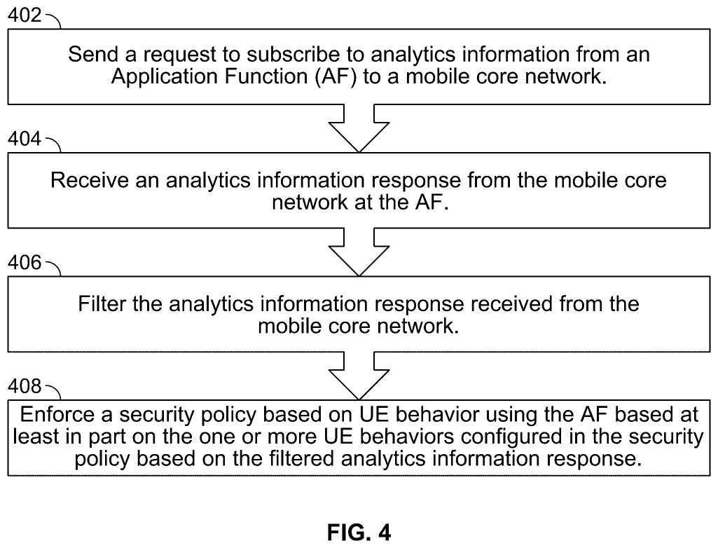

FIG. 4 is another flow diagram of a process for providing security policy enforcement per UE behavior in mobile networks in accordance with some embodiments.

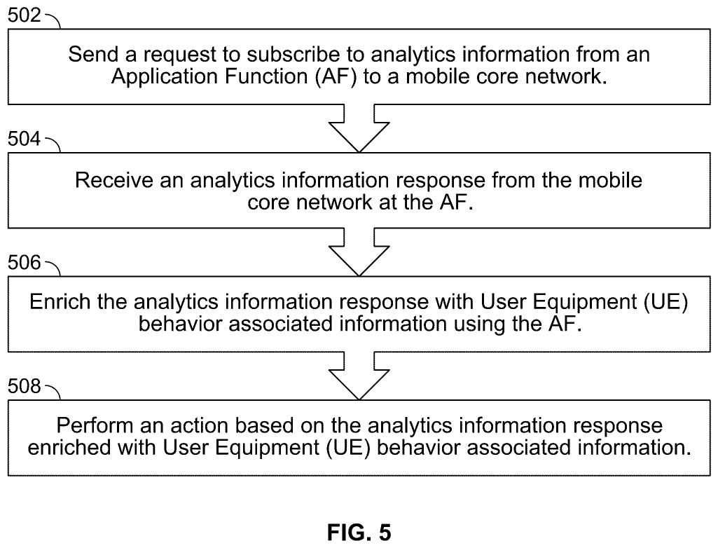

FIG. 5 is a flow diagram of a process for providing enriched analytics information per UE behavior in mobile networks in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

### Overview of Techniques for Security Policy Per User Equipment (UE) Behavior in Mobile Networks

User Equipment devices (UEs) including, for example, Internet of Things (IoT) devices, Operational Technology (OT) devices, mobile phones, tablets, and other devices with a mobile SIM card, that are executing malware (e.g., malicious software, such as a malicious application (app) or other compromised/malicious software/apps), can often behave in an abnormal (e.g., anomalous) manner.

Examples of such abnormal behavior that result from a UE executing malware can include the following: frequently connecting or disconnecting from the mobile network (e.g., a cellular network, such as a 4G, 5G, 6G, or later generation cellular network); sending a high volume of data or control traffic; and/or presenting at an unexpected location.

Technical challenges exist at detecting such UE behavior in mobile networks.

Accordingly, new and improved techniques for providing security policy enforcement per User Equipment (UE) behavior in mobile networks are disclosed.

In some embodiments, a system, a process, and/or a computer program product for providing security policy enforcement per UE behavior in mobile networks includes sending a request to subscribe to analytics information from an Application Function (AF) to a mobile core network; receiving an analytics information response from the mobile core network at the AF; and applying security policy enforcement based on User Equipment (UE) behavior using the AF based at least in part on the one or more UE behaviors configured in the security policy based on the analytics information response

In some embodiments, a system, a process, and/or a computer program product for providing security policy enforcement per UE behavior in mobile networks further includes filtering the analytics information response based on UE behavior, UE location, UE type, and/or UE category.

In an example implementation, the one or more UE behaviors (e.g., abnormal UE behaviors) can include an unexpected UE network slice, an unexpected UE Access Point Name (APN)/Data Network Name (DNN), an unexpected UE bitrate, an unexpected UE Quality of Service (QoS), and/or various other UE behaviors such as further described below.

In an example implementation, the AF is a security platform (e.g., or another security related function or service as further described below) that is located outside the mobile core network. Also, the mobile core network can be a 5G mobile core network and/or a later generation mobile network.

For example, the disclosed techniques facilitate providing network security based on UE behavior, such as will be further described below with respect to various embodiments.

As another example, the disclosed techniques facilitate enforcement of a new security policy matching criteria based on UE behavior, such as will be further described below with respect to various embodiments.

Various system embodiments for providing security policy enforcement per UE behavior in mobile networks will now be further described below.

### Example System Embodiments for Security Policy Enforcement Per User Equipment (UE) Behavior in Mobile Networks

In example system embodiments, a security platform or a security management tool acting as an application function (AF) is deployed in a mobile network.

In an example implementation, a security platform or a security management tool including, for example, a security platform (e.g., an NGFW, a security response application (app) that integrates network, endpoint, and cloud data (e.g., Cortex, which is commercially available from Palo Alto Networks, Inc., headquartered in Santa Clara, CA, or another security response app)), a security cloud management solution (e.g., Strata Cloud Manager (SCM) which is commercially available from Palo Alto Networks, Inc., headquartered in Santa Clara, CA, or another commercially available security cloud management solution), a security platform management solution (e.g., Panorama, which is commercially available from Palo Alto Networks, Inc., headquartered in Santa Clara, CA, or another commercially available security platform management solution), and/or a secure access service edge (SASE) cloud solution (e.g., Prisma SASE, which is commercially available from Palo Alto Networks, Inc., headquartered in Santa Clara, CA, or another commercially available SASE cloud solution) can request analytics information related to abnormal UE behavior from, for example, a 3GPP Network Data Analytics Function (NWDAF) (e.g., as defined in 3GPP Technical Specification (TS) 23.288 version 18.6.0 Release 18 for 5G; Architecture enhancements for 5G System (5GS) to support network data analytics services, which is publicly available at https://www.etsi.org/deliver/etsi_ts/123200_123299/123288/18.06.00_60/ts_123288v180600p.p df).

In some cases, the analytics information can be enriched with UE/device level threat data from internal and/or external sources. As an example, the security platform can use the abnormal UE information to either allow, alert, or block the network traffic of a UE or group of UEs based on the filters defined per exception ID and other context (e.g., as defined in 3GPP TS 23.288 version 18.6.0 Release 18 for 5G; Architecture enhancements for 5G System (5GS) to support network data analytics services).

Specifically, the security platform or a security management tool can request the analytics information related to abnormal UE behavior from a 3GPP NWDAF network function (e.g., using, for example, Radius protocol communications to request the analytics information related to abnormal UE behavior from the 3GPP NWDAF network function), such as will be further described below with respect to FIGS. 1A and 1B.

FIG. 1A is an example deployment architecture diagram for providing security policy enforcement per User Equipment (UE) behavior in mobile networks in accordance with some embodiments. Various other deployment architectures can similarly be implemented for providing security policy enforcement per UE behavior in mobile networks (e.g., 4G, 5G, 6G, or later generation mobile networks).

Specifically, FIG. 1A illustrates a first example deployment of an Application Function (AF) 130 (e.g., an NGFW or other security platform/device/entity, such as similarly described above, including, for example, a security response application (app) that integrates network, endpoint, and cloud data (e.g., Cortex, which is commercially available from Palo Alto Networks, Inc., headquartered in Santa Clara, CA, or another security response app)), a security cloud management solution (e.g., Strata Cloud Manager (SCM) which is commercially available from Palo Alto Networks, Inc., headquartered in Santa Clara, CA, or another commercially available security cloud management solution), a security platform management solution (e.g., Panorama, which is commercially available from Palo Alto Networks, Inc., headquartered in Santa Clara, CA, or another commercially available security platform management solution), and/or a secure access service edge (SASE) cloud solution (e.g., Prisma SASE, which is commercially available from Palo Alto Networks, Inc., headquartered in Santa Clara, CA, or another commercially available SASE cloud solution).

More specifically, AF 130 is in communication with a Network Exposure Function (NEF) 118 that is located in an example 5G Core network 106. Generally, in 5G networks, the Network Exposure Function (NEF) acts as a secure gateway, enabling third-party applications, such as in AF 130 in this example deployment, to access and interact with the mobile core network's (106) capabilities and data through standardized APIs, fostering new services, such as described herein.

NEF 118 is in communication with a Network Data Analytics Function (NWDAF) for providing security policy enforcement per UE behavior in mobile networks, such as will also be further described below with respect to FIG. 1B. Generally, in 5G networks, the Network Data Analytics Function (NWDAF) is a component that collects, analyzes, and utilizes network data to provide insights for network optimization, traffic prediction, security enhancement, and service assurance, enabling data-driven decisions for improved efficiency and user experience. As will also be further described below with respect to FIG. 1B, the NWDAF is also in communication with a Consumer Network Function (NF) 114 (e.g., also referred to as a CNF), which generally is a network function that requests and consumes resources or services from other network functions or resources in a 5G network.

As also shown in FIG. 1A, the network traffic passes from UE and IoT/OT devices 102 connecting to the 5G Core network 106 via 5G Radio Access Network (RAN) devices 104 and through the 5G Core network 106 to a Packet Data Network (PDN)/the Internet as shown at 120. In this example implementation, the 5G Core network 106 includes an Access and Mobility Management Function (AMF) 108 (e.g., a control plane function that manages UE registration, authentication, authorization, and mobility, acting as an entry point for 5G devices/UEs in a 5G Core network), a Session Management Function (SMF) 110 (e.g., a control plane function that is responsible for session management with the supported individual functions on a per-session basis for 5G devices/UEs in a 5G Core network), and a User Plane Function (UPF) 112 (e.g., a user plane function responsible for handling user data traffic, ensuring efficient packet routing, forwarding and QoS management for 5G devices/UEs in a 5G Core network, and acting as a gateway between the UEs and the rest of the network) that can be used to implement the disclosed techniques, such as will be further described below with respect to FIG. 1B.

In addition, AF 130 can also be in network communication with a Cloud Security Service (CSS) 122 (e.g., a cloud security service, such as a commercially available cloud-based security service, such as the WildFire™ cloud-based malware analysis environment that is a commercially available CSS provided by Palo Alto Networks, Inc., which includes automated security analysis of malware samples as well as security expert analysis, or a similar solution provided by another vendor can be utilized), such as via the Internet. For example, the CSS can be utilized to provide the AF 130 (e.g., NFGW/Security Platform) with dynamic prevention signatures for malware, DNS, URLs, CNC malware, and/or other malware as well as to receive malware samples for further security analysis. As will now be apparent, network traffic communications can be monitored/filtered using one or more security platforms for network traffic communications in various locations within the 5G network to facilitate enhanced security for 4G, 5G, 6G, and later versions of these mobile network environments, as will now be further described with respect to various embodiments.

FIG. 1B is a sequence diagram for providing security policy enforcement per UE behavior in mobile networks in accordance with some embodiments. In an example implementation, the disclosed techniques can be implemented using the sequence of communications (e.g., messages, Application Programming Interface (API) calls, and/or other communication mechanisms) in the 5G deployment architecture shown in and described above with respect to FIG. 1A and/or in various other deployment architectures that can similarly be implemented for providing security policy enforcement per UE behavior in mobile networks (e.g., 4G, 5G, 6G, or later generation mobile networks).

Specifically, FIG. 1B illustrates an example implementation of providing security policy enforcement per UE behavior in mobile networks. In this example implementation, a sequence diagram is provided to illustrate the communication process for NWDAF (116) assisted misused or hijacked UEs identification (e.g., pursuant to 3GPP Technical Specification (TS) 23.288 version 18.6.0 Release 18 for 5G; Architecture enhancements for 5G System (5GS) to support network data analytics services, which is publicly at available https://www.etsi.org/deliver/etsi_ts/123200_123299/123288/18.06.00_60/ts_123288v180600p.p df).

At 140, a Subscription related communication is sent from Consumer NF 114 (e.g., shown as a Nnwdaf_AnalyticsSubscription_Subscriber/Nnwdaf_AnalyticsInfo_Request) to NWDAF 116.

At 142, a Subscribe related communication is sent from AF 130 (e.g., shown as a Nnef_AnalyticsExposure_Subscribe/Nnwdaf_AnalyticsInfo_Request) to NEF 118. For example, the AF can request the analytics information related to abnormal UE behavior from a 3GPP NWDAF network function, such as for an Analytics ID= “Abnormal behavior” as well as other parameters, such as any/all UEs or a subset of UEs based on predetermined UE categories, UE types, etc., such as will be further described below. Optionally, the AF can also request the analytics information based on predetermined Analytics Filters and/or time related parameters, such as also further described below.

At 144, the Subscribe related communication is sent from NEF 118 (e.g., shown as a Nnwdaf_AnalyticsSubscription_Subscribe) to NWDAF 116.

At 146, an Event ID related communication is sent from NWDAF 116 (e.g., shown as a Namf_EventExposure_Subscribe (Event ID)) to AMF 108.

At 148, a Notify related communication is sent from AMF 108 (e.g., shown as a Namf_EventExposure_Notify) to NWDAF 116.

At 150, an Event ID related communication is sent from NWDAF 116 (e.g., shown as a Nsmf_EventExposure_Subscribe (Event ID)) to SMF 110.

At 152, a Notify related communication is sent from SMF 110 (e.g., shown as a Nsmf_EventExposure_Notify) to NWDAF 116.

At 154, data analytics for misbehavior UE identification are stored at NWDAF 116.

At 156, an Exception ID related communication is sent from NWDAF 116 (e.g., shown as a Nnwdaf_AnalyticsSubscription_Notify/Nnwdaf_AnalyticsInfo_Request Response (Exception ID)) to Consumer NF 114.

At 158, the Exception ID related communication is sent from NWDAF 116 (e.g., shown as a Nnwdaf_AnalyticsSubscription_Notify/Nnwdaf_AnalyticsInfo_Request Response (Exception ID)) to NEF 118.

Finally, at 160, the Exception ID related communication is sent from NEF 118 (e.g., shown as a Nnef_AnalyticsExposure_Notify (Exception ID)) to AF 130.

In an example implementation, AF 130 is configured with a security policy that includes one or more rules based on UE behavior in mobile networks, such as shown in FIG. 2 as further described below. As such, AF 130 can perform various actions based on the security policy to facilitate security policy enforcement per UE behavior in mobile networks as described herein.

An example security policy per UE behavior will now be further described below with respect to FIG. 2.

FIG. 2 is a table illustrating an example security policy per UE behavior in mobile networks in accordance with some embodiments.

Referring to FIG. 2, in this example security policy, a UE Behavior column 202 includes examples of different types of UE behaviors/abnormal behaviors. Examples of such potential UE abnormal behaviors include, as shown at 202, Unexpected UE Network Slice, Unexpected UE Access Point Name (APN)/Data Network Name (DNN), Unexpected UE Bitrate, and Unexpected UE QoS.

As shown at 204, a Description field can (optionally) be provided for a user description (e.g., a network/security/Information Technology (IT) administrator (admin) user) for the UE behavior rule.

As shown at 206, a UEs drop down list allows a user (e.g., a network/security/IT admin user) to select whether to apply the UE behavior rule to all or a subset of UEs. For example, the drop down list can include an option to select UEs based on International Mobile Subscription Identity (IMSI)/Subscription Permanent Identifier (SUPI), International Mobile Equipment Identity (IMEI)/Permanent Equipment Identifier (PEI), Mobile Station International Subscriber Directory Number (MSISDN), Network Access Identifier (NAI), geographical location, IoT device type, OT device type, and/or other mobile related identities/categories/types.

Various example use cases for providing a security policy per UE behavior in mobile networks will be described below.

### Example Use Cases for Security Policy Enforcement per User Equipment (UE) Behavior in Mobile Networks

Various example use cases for providing a security policy per UE behavior in mobile networks will now be described below.

For example, the AF (e.g., AF 130 as shown in FIGS. 1A and 1B) can be a security platform or a security management tool (e.g., or various example application functions, such as similarly described above, an NGFW or other security platform/device/entity, such as similarly described above, including, for example, a security response application (app) that integrates network, endpoint, and cloud data (e.g., Cortex, which is commercially available from Palo Alto Networks, Inc., headquartered in Santa Clara, CA, or another security response app)), a security cloud management solution (e.g., Strata Cloud Manager (SCM) which is commercially available from Palo Alto Networks, Inc., headquartered in Santa Clara, CA, or another commercially available security cloud management solution), a security platform management solution (e.g., Panorama, which is commercially available from Palo Alto Networks, Inc., headquartered in Santa Clara, CA, or another commercially available security platform management solution), and/or a secure access service edge (SASE) cloud solution (e.g., Prisma SASE, which is commercially available from Palo Alto Networks, Inc., headquartered in Santa Clara, CA, or another commercially available SASE cloud solution) that can request the analytics information related to abnormal UE behavior from a 3GPP NWDAF network function indicating the following as provided below.

$$Analytics ID = “ Abnormal behavior ” .$$

Target of Analytics Report.
i. Any or list of UEs.

An Analytics target period indicates the time period over which the statistics or predictions are requested.

Also, an Analytics Filter Information can optionally be specified for the analytics subscription, including the following example filtering parameters:
i. Expected UE behavior parameters;
ii. Expected analytics type or list of Exception IDs with associated thresholds for the Exception Level, in which the expected analytics type can be mobility related, communication related, or both;
iii. Area of interest (e.g., geographical location);
iv. Application (App) ID;
v. APN/DNN; and/or
vi. Network Slice (e.g., Single-Network Slice Selection Assistance Information (S-NSSAI)).

Optionally, the Filter Information can include parameters specifying a maximum number of objects and a maximum number of IMSIs/SUPIs.

In an example security service subscription, the Notification Correlation ID and the Notification Target Address can also be included.

As also shown in FIG. 2 at 208, various actions can be configured to be performed based on a match of the UEs (206) and UE Behavior (202) to a received analytics information response (e.g., such as shown at 154 in FIG. 1B and provided via a notification communication to AF (130) at 160 as shown in FIG. 1B).

For example, applying the above-described techniques, security policy enforcement per UE in mobile networks can be performed based on potential UE abnormal behaviors including an Unexpected UE Network Slice.

As another example, applying the above-described techniques, security policy enforcement per UE in mobile networks can be performed based on potential UE abnormal behaviors including an Unexpected UE Access Point Name (APN)/Data Network Name (DNN).

As yet another example, applying the above-described techniques, security policy enforcement per UE in mobile networks can be performed based on potential UE abnormal behaviors including an Unexpected UE Bitrate.

As a further example, applying the above-described techniques, security policy enforcement per UE in mobile networks can be performed based on potential UE abnormal behaviors including an Unexpected UE QoS.

As yet a further example, applying the above-described techniques, security policy enforcement per UE in mobile networks can be performed based on potential UE abnormal behaviors including one or more of any combination of the UE behaviors shown at 202 in the example security policy based on UE behavior in mobile networks as shown in and described above with respect to FIG. 2.

Additional example process embodiments for providing security policy enforcement per UE behavior in mobile networks will be further described below.

### Example Process Embodiments for Security Policy Enforcement Per User Equipment (UE) Behavior in Mobile Networks

Various process embodiments for providing security policy enforcement per UE behavior in mobile networks will now be further described below.

FIG. 3 is a flow diagram of a process for providing security policy enforcement per UE behavior in mobile networks in accordance with some embodiments. In some embodiments, a process as shown in FIG. 3 is performed by the AF (130) in communication with other components and techniques as similarly described above including the embodiments described above with respect to FIGS. 1A, 1B, and 2.

At 302, a request to subscribe to analytics information is sent from an Application Function (AF) to a mobile core network. For example, AF (130) can be configured to subscribe to analytics information via NEF (118) and NWDAF (116) as similarly described above with respect to FIGS. 1A and 1B.

At 304, an analytics information response is received from the mobile core network at the AF. For example, NWDAF (116) and NEF (118) can provide data analytics for misbehavior UE identification to AF (130), such as similarly described above with respect to FIGS. 1A and 1B.

At 306, enforcing a security policy based on UE behavior (e.g., abnormal UE behavior) using the AF based at least in part on the one or more UE behaviors configured in the security policy is performed. For example, the security platform can be configured to enforce a security policy (e.g., including one or more rules) based on the analytics information response. Various security policy enforcement rules and actions can be performed, such as similarly described above with respect to FIG. 2.

FIG. 4 is another flow diagram of a process for providing security policy enforcement per UE behavior in mobile networks in accordance with some embodiments. In some embodiments, a process as shown in FIG. 3 is performed by the AF (130) in communication with other components and techniques as similarly described above including the embodiments described above with respect to FIGS. 1A, 1B, and 2.

At 402, a request to subscribe to analytics information is sent from an Application Function (AF) to a mobile core network. For example, AF (130) can be configured to subscribe to analytics information via NEF (118) and NWDAF (116) as similarly described above with respect to FIGS. 1A and 1B. For example, NWDAF (116) and NEF (118) can provide data analytics for misbehavior UE identification to AF (130), such as similarly described above with respect to FIGS. 1A and 1B.

At 404, an analytics information response is received from the mobile core network at the AF.

At 406, filtering the analytics information response received from the mobile core network is performed. For example, as similarly described above, an Analytics Filter Information can optionally be specified for the analytics subscription, including the following example filtering parameters:
i. Expected UE behavior parameters;
ii. Expected analytics type or list of Exception IDs with associated thresholds for the Exception Level, in which the expected analytics type can be mobility related, communication related, or both;
iii. Area of interest (e.g., geographical location);
iv. Application (App) ID;
v. APN/DNN; and/or
vi. Network Slice (e.g., Single-Network Slice Selection Assistance Information (S-NSSAI)).

Optionally, the Filter Information can include parameters specifying a maximum number of objects and a maximum number of IMSIs/SUPIs.

In an example security service subscription, the Notification Correlation ID and the Notification Target Address can also be included.

At 408, enforcing a security policy based on UE behavior (e.g., abnormal UE behavior) using the AF based at least in part on the one or more UE behaviors configured in the security policy is performed. For example, the security platform can be configured to enforce a security policy (e.g., including one or more rules) based on the filtered analytics information response. Various security policy enforcement rules and actions can be performed, such as similarly described above with respect to FIG. 2.

FIG. 5 is a flow diagram of a process for providing enriched analytics information per UE behavior in mobile networks in accordance with some embodiments. In some embodiments, a process as shown in FIG. 3 is performed by the AF (130) in communication with other components and techniques as similarly described above including the embodiments described above with respect to FIGS. 1A, 1B, and 2.

At 502, a request to subscribe to analytics information is sent from an Application Function (AF) to a mobile core network. For example, AF (130) can be configured to subscribe to analytics information via NEF (118) and NWDAF (116) as similarly described above with respect to FIGS. 1A and 1B.

At 504, an analytics information response is received from the mobile core network at the AF. For example, NWDAF (116) and NEF (118) can provide data analytics for misbehavior UE identification to AF (130), such as similarly described above with respect to FIGS. 1A and 1B.

At 506, enriching the analytics information response with User Equipment (UE) behavior associated information is performed using the AF. In an example implementation, the UE behavior is associated with device related threat data from an internal source and/or an external source, such as similarly described above.

At 508, an action is performed based on the analytics information response enriched with User Equipment (UE) behavior associated information. As an example, the security platform can use the abnormal UE information to either allow, alert, or block the network traffic of a UE or group of UEs based on the filters defined per exception ID and other context (e.g., as defined in 3GPP TS 23.288 version 18.6.0 Release 18 for 5G; Architecture enhancements for 5G System (5GS) to support network data analytics services).

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a processor configured to:
send a request to subscribe to analytics information from an Application Function (AF) to a mobile core network;
receive an analytics information response from the mobile core network at the AF; and
apply security policy enforcement based on User Equipment (UE) behavior using the AF based at least in part on one or more UE behaviors configured in a security policy based on the analytics information response; and
a memory coupled to the processor and configured to provide the processor with instructions.

2. The system recited in claim 1, wherein the one or more UE behaviors include an unexpected UE network slice.

3. The system recited in claim 1, wherein the one or more UE behaviors include an unexpected UE Access Point Name (APN)/Data Network Name (DNN).

4. The system recited in claim 1, wherein the one or more UE behaviors include an unexpected UE bitrate.

5. The system recited in claim 1, wherein the one or more UE behaviors include an unexpected UE Quality of Service (QoS).

6. The system recited in claim 1, wherein the AF is a security platform that is located outside the mobile core network.

7. The system recited in claim 1, wherein the AF is a security platform that is located outside the mobile core network, and wherein the mobile core network includes a 5G mobile core network.

8. The system recited in claim 1, wherein the processor is further configured to:
deny or block network traffic associated with the UE behavior based on the security policy.

9. The system recited in claim 1, wherein the processor is further configured to:
filter the analytics information response based on the UE behavior, UE location, UE type, and/or UE category.

10. A method, comprising:
sending a request to subscribe to analytics information from an Application Function (AF) to a mobile core network;
receiving an analytics information response from the mobile core network at the AF; and
applying security policy enforcement based on User Equipment (UE) behavior using the AF based at least in part on one or more UE behaviors configured in a security policy based on the analytics information response.

11. The method of claim 10, wherein the one or more UE behaviors include an unexpected UE network slice.

12. The method of claim 10, wherein the one or more UE behaviors include an unexpected UE Access Point Name (APN)/Data Network Name (DNN).

13. The method of claim 10, wherein the one or more UE behaviors include an unexpected UE bitrate.

14. The method of claim 10, wherein the one or more UE behaviors include an unexpected UE Quality of Service (QoS).

15. The method of claim 10, wherein the AF is a security platform that is located outside the mobile core network.

16. The method of claim 10, wherein the AF is a security platform that is located outside the mobile core network, and wherein the mobile core network includes a 5G mobile core network.

17. The method of claim 10, further comprising:
denying or blocking network traffic associated with the UE behavior based on the security policy.

18. A computer program product, the computer program product being embodied in a non-transitory computer readable storage medium and comprising computer instructions for:
sending a request to subscribe to analytics information from an Application Function (AF) to a mobile core network;
receiving an analytics information response from the mobile core network at the AF; and
applying security policy enforcement based on User Equipment (UE) behavior using the AF based at least in part on one or more UE behaviors configured in a security policy based on the analytics information response.

19. The computer program product recited in claim 18, wherein the AF is a security platform that is located outside the mobile core network.

20. The computer program product recited in claim 18, further comprising computer instructions for:
denying or blocking network traffic associated with the UE behavior based on the security policy.

21. A system, comprising:
a processor configured to:
send a request to subscribe to analytics information from an Application Function (AF) to a mobile core network;
receive an analytics information response from the mobile core network at the AF;
enrich the analytics information response with User Equipment (UE) behavior associated information using the AF, wherein the UE behavior is associated with device related threat data from an internal source and/or an external source; and
perform an action based on the analytics information response enriched with User Equipment (UE) behavior associated information; and
a memory coupled to the processor and configured to provide the processor with instructions.
